(19) United States
(12) Patent Application Publication
(10) Pub. No.: US 2005/0281479 A1
(43) Pub. Date: Dec. 22, 2005

(54) Method of and apparatus for estimating noise of input image based on motion compensation, method of eliminating noise of input image and encoding video using the method for estimating noise of input image, and recording media having recorded thereon program for implementing those methods

(75) Inventor: Byung-cheol Song, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/102,733

(22) Filed: Apr. 11, 2005

(30) Foreign Application Priority Data
Jun. 16, 2004 (KR) 10-2004-0044508

(51) Int. Cl. G06K 9/40; G06K 9/36

(52) U.S. Cl. 382/275; 382/236

(57) ABSTRACT

A method of and an apparatus for estimating noise based on motion compensation. The method includes estimating a motion vector for a predetermined-size current block of the input image, calculating a difference between a block corresponding to the estimated motion vector and the current block, comparing the calculated difference with a predetermined threshold value, selectively updating a noise estimation value for estimation of the noise of the input image according to a result of the comparison, generating information about the noise based on the selectively updated noise estimation value.

### BACKGROUND OF THE INVENTION

This application claims priority from Korean Patent Application No. 10-2004-0044508, filed on Jun. 16, 2004 in the Korean Intellectual Property Office, the disclosure of which is incorporated herein in its entirety by reference.

1. Field of the Invention

The present invention relates to a method of and apparatus for estimating noise, and more particularly, to a method of and apparatus for estimating noise and a method of effectively eliminating noise based on a result of estimation when an image distorted by noise is input to a video encoder that is based on motion compensation (MC) and discrete cosine transform (DCT), like Moving Picture Experts Group (MPEG)-2 and MPEG-4.

2. Description of the Related Art

Set top boxes have been introduced recently, which receive analog ground wave broadcasting and encode the same using a compression technique like MPEG-2 or MPEG-4. However, an image that is input to a receiver is mostly distorted by various types of noise like white Gaussian noise through a transmission channel.

For example, the entire image is distorted by various types of noise like white Gaussian noise. When such an image is intactly compressed, the compression efficiency is degraded due to noise.

Thus, studies have been actively conducted to eliminate noise from video. However, since conventional noise elimination methods are implemented in the basic assumption that the amount of noise is recognized to a certain extent, various noise estimation methods are used.

European Patent Publication No. 712554 discloses an example of the noise estimation methods.

Hereinafter, a conventional noise elimination method will be described with reference to FIG. 1.

FIG. 1 is a block diagram of a conventional noise estimation apparatus.

The conventional noise estimation apparatus includes a first subtractor 112, a frame memory 114, a first absolute value calculator 116, a first low pass filter 118, a second low pass filter 120, a second subtractor 122, a second absolute value calculator 124, a third subtractor 126, a third absolute value calculator 128, an adder 130, and a amount-of-noise estimator 132.

The first subtractor 112 calculates a difference between a current input image and an image that is adjacent to the current input image and is stored in the frame memory 114. The calculated difference between the two adjacent images is input to the first absolute value calculator 116. The first absolute value calculator 116 inputs the calculated absolute value to the third subtractor 126.

The second subtractor 122 calculates a difference between the current input image that passes through the first low pass filter 118 and the adjacent image that passes through the second low pass filter 120. The calculated difference between the two low pass filtered images is input to the second absolute value calculator 124. The second absolute value calculator 124 inputs the calculated absolute value to the third subtractor 126.

The third subtractor 126 calculates a difference between the calculated absolute value of the first absolute value calculator 116 and the calculated absolute value of the second absolute value calculator 124 and inputs the calculated difference to the third absolute value calculator 128. The third absolute value calculator 128 calculates an absolute value of the calculated difference of the third subtractor 126 and outputs the calculated absolute value to the adder 130.

The adder 130 adds up the calculated absolute value output from the third absolute value calculator 128 in frame units.

The amount-of-noise estimator 132 determines the amount of noise included in the input image based on a result of adding up of the adder 130.

The conventional noise estimation apparatus determines that there is much noise in the input image if the result of adding up in frame units is large. If the result of adding up is small, the conventional noise estimation apparatus determines that there is a little noise in the input image.

Such a conventional noise estimation apparatus based on motion can estimate noise in an image that shows little motion, but in an image that shows much motion, the result of adding up of the adder 130 gets larger due to motion. Consequently, in an image that shows much motion, it is difficult to estimate noise.

To solve the problem, there is an intraframe noise estimation method. The intraframe noise estimation method obtains flat blocks within an input image using a two-dimensional high pass filter as shown in FIG. 2 in the assumption that variance in a flat area of the input image is similar to that of noise and estimates noise by calculating the variance of the flat blocks.

However, a conventional intraframe noise estimation apparatus has a difficulty in estimating noise in an input image having few flat areas, i.e., an input image having a complex texture.

### SUMMARY OF THE INVENTION

The present invention provides a method of and an apparatus for estimating noise, in which noise is effectively estimated using motion information while improving a conventional noise estimation method, and a recording medium having recorded thereon a program for implementing the method.

The present invention also provides a method of eliminating noise using the method of estimating noise and a recording medium having recorded thereon a program for implementing the method.

The present invention also provides a method of encoding video using the method of estimating noise and a recording medium having recorded thereon a program for implementing the method.

According to one aspect of the present invention, there is provided a method of estimating noise of an input image, the method including: estimating a motion vector for a predetermined-size current block of the input image; calculating a difference between a block corresponding to the estimated motion vector and the current block; comparing the calculated difference with a predetermined threshold value; selectively updating a noise estimation value for estimation of the noise of the input image according to a result of the comparison; generating information about the noise based on the selectively updated noise estimation value.

According to another aspect of the present invention, there is provided a method of estimating and eliminating noise of an input image, the method including: estimating a motion vector for a predetermined-size current block of the input image; calculating a difference between a block corresponding to the estimated motion vector and the current block; comparing the calculated difference with a predetermined threshold value; selectively updating a noise estimation value for estimation of the noise of the input image according to a result of the comparison; performing filtering for elimination of the noise of the input image based on the selectively updated noise estimation value.

According to still another aspect of the present invention, there is provided a method of encoding video, the method including: estimating a motion vector for a predetermined-size current block of the input image; calculating a difference between a block corresponding to the estimated motion vector and the current block; comparing the calculated difference with a predetermined threshold value; selectively updating a noise estimation value for estimation of the noise of the input image according to a result of the comparison; determining a modified quantization weight matrix based on the information about the noise generated in operation (d); performing discrete cosine transform on the input image; and quantizing the discrete cosine transformed input image using the modified quantization weight matrix determined in the determining of the modified quantization weight matrix.

According to yet another aspect of the present invention, there is provided an apparatus for estimating noise of an input image, the apparatus comprising: a motion estimation unit estimating a motion vector for a predetermined sized current block of the input image and calculating a difference between a block corresponding to the estimated motion vector and the current block; a comparing unit comparing the calculated difference with a predetermined threshold value; and a noise calculating unit selectively updating a noise estimation value for estimation of the noise of the input image according to a result of the comparison and generating information about the noise based on the selectively updated noise estimation value.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional noise estimation apparatus;

FIG. 2 shows a two-dimensional high pass filter used in a conventional intraframe noise estimation method;

FIG. 3 is a block diagram of an apparatus for estimating noise according to the present invention;

FIGS. 4A and 4B are views for explaining multi-resolution motion estimation;

FIG. 5 is a flowchart illustrating a method of estimating noise according to an embodiment of the present invention;

FIG. 6 shows an example in which the apparatus for estimating noise according to the present invention is implemented;

FIG. 7 is a block diagram of a general MPEG video encoder;

FIG. 8 is a block diagram of an improved video encoder according to an embodiment of the present invention; and

FIG. 9 is a block diagram of an improved video encoder according to another embodiment of the present invention.

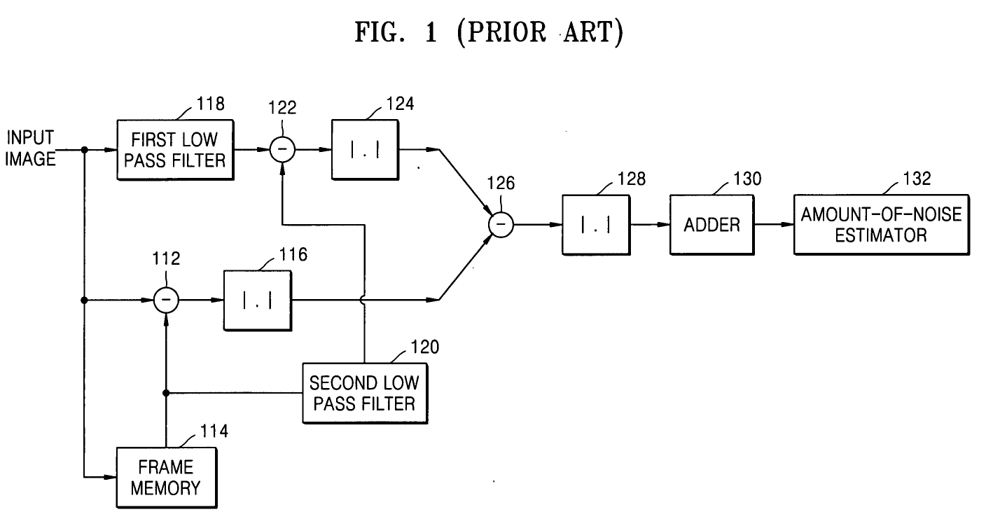

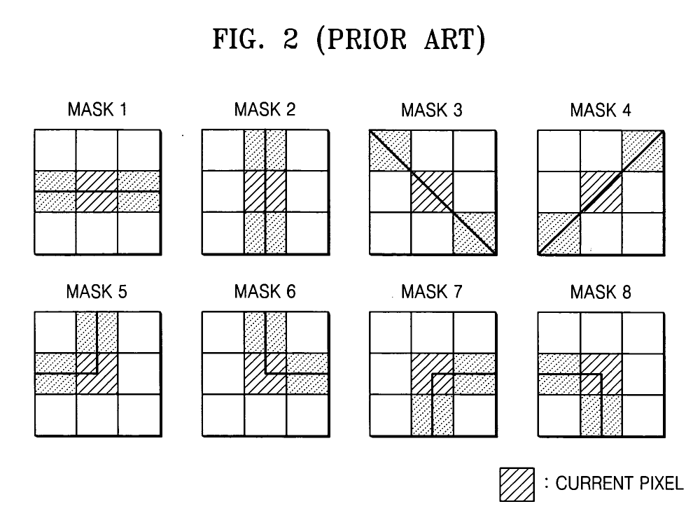

### DETAILED DESCRIPTION OF THE EXEMPLARY EMBODIMENTS OF THE INVENTION

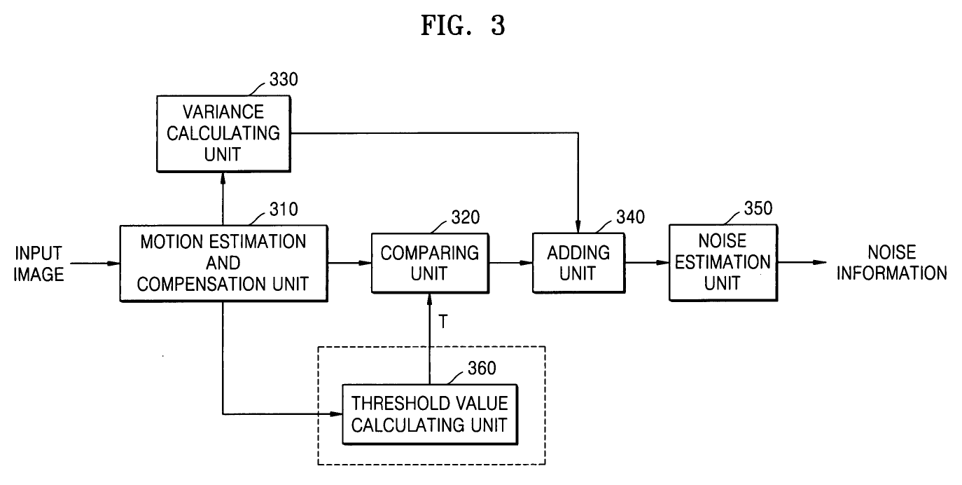

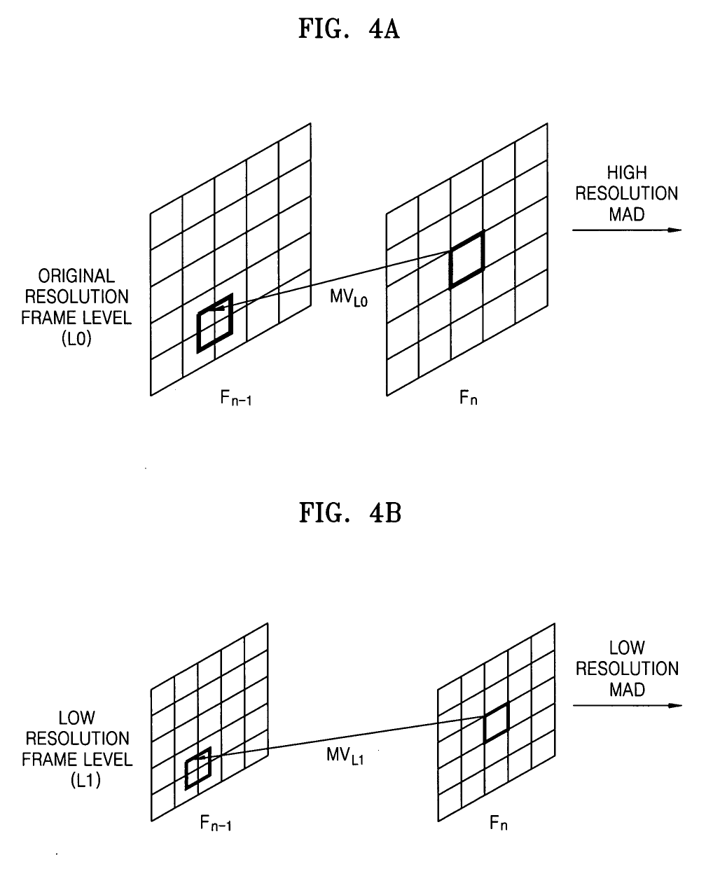

Hereinafter, a method of estimating noise according to the present invention will be described with reference to FIGS. 3, 4A, and 4B.

FIG. 3 is a block diagram of an apparatus for estimating noise according to the present invention.

The apparatus for estimating noise includes a motion estimation and compensation unit 310, a comparing unit 320, a variance calculating unit 330, an adding unit 340, and a noise estimation unit 350. Selectively, the apparatus for estimating noise may further include a threshold calculating unit 360.

The motion estimation and compensation unit 310 detects a motion vector MV_{L0} at an original resolution frame level L0 and a motion vector MV_{L1} at a low resolution frame level L1 with respect to a block at a position (i, j) in a current frame, using multi-resolution motion estimation as shown in FIGS. 4A and 4B. In this embodiment, motion vector detection uses multi-resolution motion estimation, but it may selectively use motion estimation that is typically used in conventional video encoders.

For example, as shown in FIG. 4A, the current frame is divided into non-overlapped blocks of N×N (N=16) and motion estimation is performed for each of the blocks. In multi-resolution motion estimation, motion estimation is performed in L stages. However, in this embodiment, L is equal to 2. In this embodiment, L0 means an original resolution stage in FIG. 4A and L1 means a low resolution stage in FIG. 4B.

In this embodiment, low pass filtering is performed on a low resolution image in pixel units. For low pass filtering, for example, a 2×2 average filter is used. More elaborate low pass filtering can be performed in consideration of the amount of computation, or selectively, a low-resolution image can be obtained using sub-sampling without low pass filtering. Alternatively, low pass filtering can be only performed without sub-sampling to obtain a low-resolution image.

Frames at L0 are 1:2 sub-sampled horizontally and vertically using multi-resolution motion estimation, and a motion vector per 8×8 block is calculated at L1. Here, a motion vector is calculated at a low-resolution level to reduce the amount of computation required for calculation of a motion vector by reducing the size of a detection area.

Also, at the original resolution frame level L0, a motion vector per 16×16 block corresponding to each 8×8 block is calculated using a motion vector obtained at the low resolution frame level L1.

As such, in multi-resolution motion estimation, motion vector detection is first performed at the low resolution frame level L1 to obtain MV_{L1}, and local detection is performed in a small area at the original resolution frame level L0 using the obtained motion vector MV_{L1}.

When the motion vector at L0 is MV_{L0}, MV_{L0} is given by

$${MV}_{L0} = arg {min}_{- S \leq p , q \leq S} {\sum }_{m = 0}^{N - 1} {\sum }_{n = 0}^{N - 1} \vert {F}_{n} ( i + m , j + n ) - {F}_{n - 1} ( i + m + p , j + n + q ) \vert , \qquad ( 1 )$$

where Fₙ (i, j) indicates a pixel at a position (i, j) in a current frame (an n^{th} frame), i.e., a pixel marked with a bold line within a current block as shown in FIG. 4A, Also, [-S, S] indicates a detection area in which a motion vector is detected, Fₙ₋₁ (i, j) indicates a pixel at a position (i, j) in a previous frame (an n-1^{th} frame), and each block has a size of N×N.

The comparing unit 320 compares a mean of absolute differences (MAD), i.e., a MAD_{L0} corresponding to the motion vector MV_{L0} of a predetermined block, e.g., a k^{th} block, obtained at L0 with a predetermined threshold value T to determine whether motion estimation and compensation is performed well and transmits a result of the determination to the adding unit 340. In other words, when MAD_{L0} of the current block obtained at L0 is less than the threshold value T, the comparing unit 320 determines that motion estimation and compensation is performed well on the current block.

The variance calculating unit 330 calculates a variance a σ²ₘᵢₙ corresponding to a motion compensated block of the current block.

When MAD_{L0} corresponding to the motion vector MV_{L0} obtained at L0 of the current block, e.g., the k^{th} block is less than the threshold value T, the adding unit 340 adds a variance of the k^{th} block to a sum of variances over all the previous blocks of the current frame, i.e., an error estimation value SUMₙₒᵢₛₑ. In this embodiment, the error estimation value SUMₙₒᵢₛₑ is initialized to 0 at a start point of the current frame. In other words, when k is equal to 0, SUMₙₒᵢₛₑ is equal to 0. The adding unit 340 calculates the error estimation value SUMₙₒᵢₛₑ as follows.
SUMₙₒᵢₛₑ=SUMₙₒᵢₛₑ+σ²ₘᵢₙ (2)

In this embodiment, the error estimation value SUMₙₒᵢₛₑ can be calculated using Equation 2, but selectively may be calculated as follows.
SUMₙₒᵢₛₑ=SUMₙₒᵢₛₑ+max{σ²ₘᵢₙ−α,0} (3),
where α is a compensation value for a case when motion compensation is not correctly performed. At this time, since σ²ₘᵢₙ−α may be a negative number, σ²ₘᵢₙ−α that is more than 0 is selected. α adaptively varies based on the degree of motion compensation of each block. In this embodiment, as shown in Equation 4, the compensation value α is obtained using MAD_{L1} corresponding to the motion vector MV_{L1} obtained at L1.
α=(MAD_{L1})² (4)

MAD_{L1} obtained at L1 is used because an error of a low-resolution image is largely eliminated through low pass filtering. However, the compensation value α may be calculated using other MAD and variances.

The noise estimation unit 350 calculates a noise variance σ²ₙₒᵢₛₑ of the current frame using the error estimation value SUMₙₒᵢₛₑ calculated by the adding unit 340 after motion estimation and compensation is completed for all the blocks of the current frame, as follows.

$${σ}_{noise}^{2} = \frac{{SUM}_{noise}}{{Num}_{block}} , \qquad ( 5 )$$

where Num_{block} indicates the number of blocks, among the blocks of the current frame, in which MAD_{L0} is less than the threshold value T. The noise estimation unit 350 estimates the strength of noise of the current frame based on the noise variance σ²ₙₒᵢₛₑ of the current frame which is calculated using Equation 5.

The noise variance σ²ₙₒᵢₛₑ of the current frame, which is calculated by the noise estimation unit 350, is used to eliminate noise of the next frame. Such elimination of the noise of the next frame will be described in detail later.

Selectively, the apparatus for estimating noise may further include a threshold calculating unit 360. The threshold value calculating unit 360 according to the embodiment of the present invention is updated for each frame according to the characteristic of each frame. For example, the threshold value T is calculated as follows.
T=minₖ(MAD_{L0}[k])+ε (6),
where MAD_{L0}[k] is MAD_{L0} of the k^{th} block of the current frame and ε is a predetermined value as a constant. As shown in Equation 6, the threshold value T is obtained by adding a minimum value among MAD_{L0} for the current frame to the predetermined value. The threshold value T calculated for the current frame is used for the next frame.

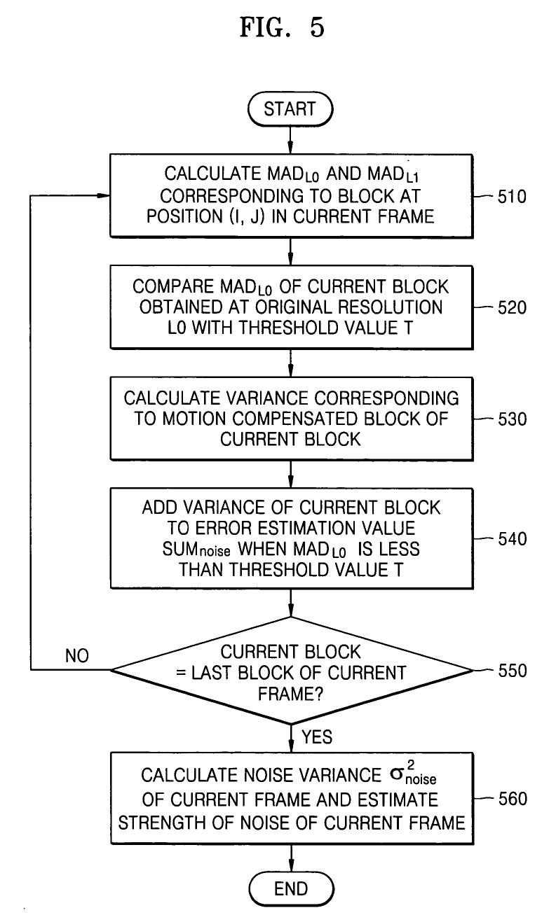

FIG. 5 is a flowchart illustrating a method of estimating noise according to an embodiment of the present invention.

In operation 510, as shown in FIGS. 4A and 4B, the motion vector MV_{L0} at the original resolution frame level and the motion vector MV_{L1} at the low resolution frame level for the block at the position (i, j) in the current frame are calculated using multi-resolution motion estimation and corresponding MAD_{L0} and MAD_{L1} are calculated.

In operation 520, MAD_{L0} corresponding to the motion vector MV_{L0} of the current block, e.g., the k^{th} block, obtained at L0 is compared with the predetermined threshold value T and it is determined whether motion estimation and compensation is performed well.

In operation 530, the variance σ²ₘᵢₙ corresponding to the motion compensated block of the current block is calculated.

In operation 540, according to a result of the comparison in operation 520, when MAD_{L0} of the current block, e.g., the k^{th} block is less than the threshold value T, a variance of the k^{th} block is added to a sum of variances over all the previous blocks of the current frame, i.e., the error estimation value SUMₙₒᵢₛₑ, using Equation 4.

In operation 550, it is determined whether the current block is the last block of the current frame. If the current block is the last block of the current frame, a process goes to operation 560. If the current block is not the last block of the current frame, operations 510 through 540 are repeated for the next block.

In operation 560, the noise variance σ²ₙₒᵢₛₑ of the current frame is calculated using Equation 5 and the strength of noise of the current frame is estimated.

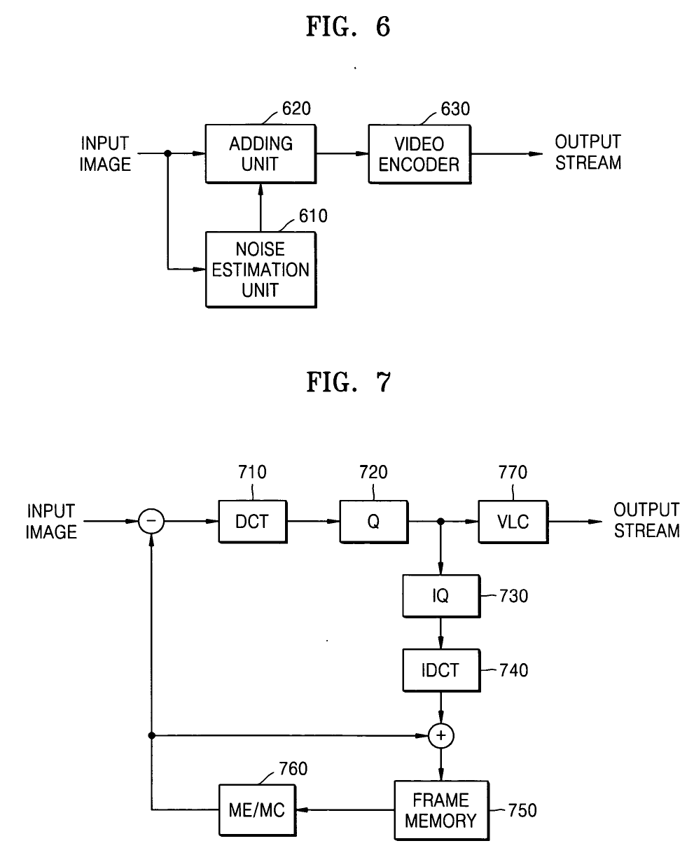

FIG. 6 shows an example in which a noise estimation unit 610 according to an exemplary embodiment of the present invention is implemented.

The noise estimation unit 610 estimates the amount of noise included in an input image according to the embodiment of FIG. 3 and outputs information about the estimated amount of noise to a pre-processing unit 620.

The pre-processing unit 620 performs general noise elimination filtering on the input image based on the input information about the estimated amount of noise.

A video encoder 630 operates in the same way as general video encoders, and the detailed operations of the video encoder 630 will not be described for brevity of explanation.

FIG. 7 is a block diagram of a general MPEG video encoder.

For video-on-demand (VOD) services or video communication, the MPEG video encoder generates bitstreams encoded using a compression technique.

First, to remove spatial correlations, discrete cosine transform (DCT) unit 710 performs a DCT operation on video data input in units of an 8×8 pixel block. A quantization (Q) unit 720 quantizes DCT coefficients obtained from the DCT unit 710 and expresses several representative values, thereby achieving high-efficiency low-loss compression.

An inverse quantization (IQ) unit 730 inversely quantizes the video data that is quantized by quantization unit 720. An inverse discrete cosine transform (IDCT) unit 740 performs IDCT on the video data that is dequantized by the IQ unit 730. A frame memory unit 750 stores the video data that is IDCT transformed by the IDCT unit 740 in frame units.

A motion estimation and compensation (ME/MC) unit 760 estimates a motion vector (MV) per macroblock and a sum of absolute differences (SAD) corresponding to a block matching error using video data of an input current frame and video data of a previous frame stored in the frame memory unit 750.

A variable length coding (VLC) unit 770 removes statistical redundancy from DCT transformed and quantized data based on the MV estimated by the ME/MC unit 760.

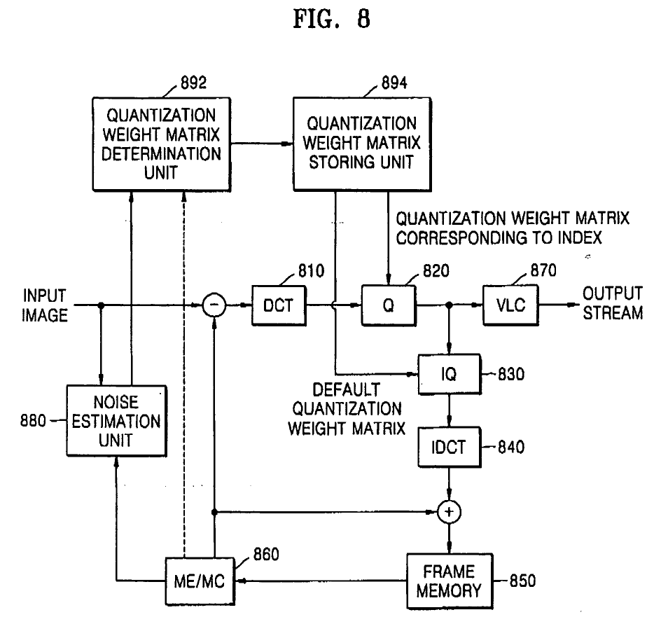

FIG. 8 is a block diagram of an improved video encoder according to an embodiment of the present invention.

A video encoder employing the method of eliminating noise according to the embodiment of the present invention adds a noise estimation unit 880, a quantization weight matrix determination unit 892, and a quantization weight matrix storing unit 894 to the general video encoder shown in FIG. 7.

A DCT unit 810, an IDCT unit 840, a frame memory unit 850, an ME/MC unit 860, and a VLC unit 870 operate in the same manner as in the general video encoder shown in FIG. 7 and their detailed operations will not be described for brevity of explanation.

The noise estimation unit 880 estimates the amount of noise included in an input image according to the embodiment of FIG. 3 and outputs information about the estimated amount of noise to the quantization weight matrix determination unit 892.

The quantization weight matrix determination unit 892 determines a quantization weight matrix based on the information about the estimated amount of noise transmitted from the noise estimation unit 880 and transmits an index of the determined quantization weight matrix to the quantization weight matrix storing unit 894. In this embodiment, the quantization weight matrix determination unit 892 determines the quantization weight matrix based on the information about the estimated amount of noise transmitted from the noise estimation unit 880, but selectively, it may perform determination based on the variance that is calculated by the ME/MC unit 860 in units of a macroblock.

In this embodiment, 5 quantization weight matrixes that are classified according to the amount of noise included in the input image are stored in the quantization weight matrix storing unit 894.

The quantization weight matrix determination unit 892 transmits the index of the determined quantization weight matrix to the quantization weight matrix storing unit 892 using the information about the estimated amount of noise input from the noise estimation unit 880. When the quantization weight matrixes stored in the quantization weight matrix storing unit 892 are classified into 5 types, the index is one of 0, 1, 2, 3, and 4.

The quantization weight matrix storing unit 894 selects a corresponding quantization weight matrix based on the index of the determined quantization weight matrix that is transmitted from the quantization weight matrix determination unit 892 and transmits the selected quantization weight matrix to the quantization unit 820.

A quantization unit 820 performs quantization using the input quantization weight matrix.

An IQ unit 830 performs inverse quantization based on an original default quantization weight matrix.

Also, new quantization weight matrixes can be determined by a user. In this embodiment, noise elimination of Y components of an input image block in a DCT domain is shown. However, the same apparatus for eliminating noise can be used for elimination of U and V components. At this time, a separate weight matrix for elimination of U and V components is required.

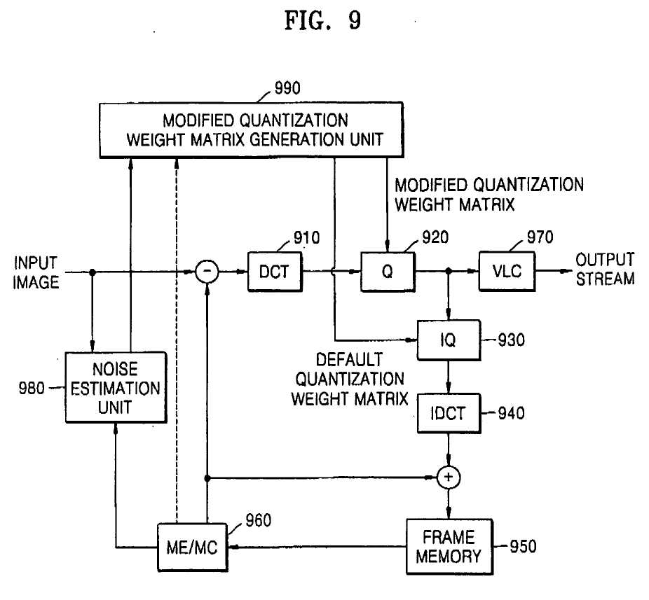

FIG. 9 is a block diagram of an improved video encoder according to another embodiment of the present invention.

A video encoder employing a method of eliminating noise according to another embodiment of the present invention adds a noise estimation unit 980 and a modified quantization weight matrix generation unit 990 to the general video encoder shown in FIG. 7.

A DCT unit 910, an IDCT unit 940, a frame memory unit 950, an ME/MC unit 960, and a VLC unit 970 operate in the same way as in the general video encoder shown in FIG. 7 and their detailed operations will not be described for brevity of explanation.

The noise estimation unit 980 estimates the amount of noise included in an input image according to the embodiment of FIG. 3 and outputs information about the estimated amount of noise to the modified quantization weight matrix generation unit 990.

The modified quantization weight matrix generation unit 990 generates a modified quantization weight matrix based on the information about the estimated amount of noise transmitted from the noise estimation unit 980 and transmits the generated modified quantization weight matrix to the quantization unit 920. In this embodiment, the modified quantization weight matrix generation unit 990 determines the modified quantization weight matrix based on the information about the estimated amount of noise transmitted from the noise estimation unit 980, but selectively, it may perform determination based on a macroblock variance calculated in units of a macroblock by the ME/MC unit 960.

A quantization unit 920 performs quantization based on the modified quantization weight matrix that is transmitted from the modified quantization weight matrix generation unit 990.

An IQ unit 930 performs inverse quantization based on an original default quantization weight matrix.

The present invention is not limited to the above-described embodiments and it will be understood by those of ordinary skill in the art that various changes in form and details may be made therein. In particular, the present invention can applied to all kinds of video encoding apparatuses and methods such as MPEG-1, MPEG-2, and MPEG 4.

As described above, the method of and the apparatus for estimating noise using motion compensation according to an exemplary embodiment of the present invention selectively updates a noise estimation value for estimation of noise of an input image based on a predetermined criterion, thereby improving the accuracy of noise estimation of the input image. Also, the method of eliminating noise adopting the method of estimating noise according to the present invention can effectively eliminate noise of an input image, thereby making it possible to more effectively encode videos using the method of encoding video adopting the method of estimating noise according to the present invention.

The present invention can also be embodied as a computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of estimating noise of an input image, the method comprising:
(a) estimating a motion vector for a predetermined-size current block of the input image;
(b) calculating a difference between a block corresponding to the estimated motion vector and the current block;
(c) comparing the calculated difference with a predetermined threshold value;
(d) selectively updating a noise estimation value for estimation of the noise of the input image according to a result of the comparison;
(e) generating information about the noise based on the selectively updated noise estimation value.

2. The method of claim 1, wherein operation (d) comprises adding a result of motion estimation for the current block to the noise estimation value only when the calculated difference is less than the predetermined threshold value.

3. The method of claim 1, wherein the calculated difference is a mean of absolute differences of the current block.

4. The method of claim 1, wherein operation (d) comprises adding a variance of the current block to the noise estimation value when the calculated difference is less than the predetermined threshold value, and the noise estimation value is a sum of variances over all previous blocks of the current block in a current frame, in which the previous blocks are processed by operations (a) through (d) and have calculated differences that are less than the predetermined threshold value.

5. The method of claim 1, wherein operation (d) comprises adding a result of subtracting a predetermined motion compensation value from the calculated difference to the noise estimation value when the calculated difference is less than the predetermined threshold value, and the noise estimation value is a sum of variances over all previous blocks of the current block in a current frame, in which the previous blocks are processed by operations (a) through (d) and have calculated differences that are less than the predetermined threshold value.

6. The method of claim 4, wherein operation (a) comprises estimating a motion vector at a low resolution image and a motion vector at an original resolution image using the estimated motion vector of the low resolution image, and the low resolution image is obtained by low pass filtering.

7. The method of claim 1, wherein operation (e) comprises:
(e1) determining whether the current block is the last block of the current frame; and
(e2) generating the information about the noise based on the noise estimation value and the number of blocks of the current frame that have calculated differences that are less than the predetermined threshold value, when the current block is the last block of the current frame.

8. A method of estimating and eliminating noise of an input image, the method comprising:
(a) estimating a motion vector for a predetermined-size current block of the input image;
(b) calculating a difference between a block corresponding to the estimated motion vector and the current block;
(c) comparing the calculated difference with a predetermined threshold value;
(d) selectively updating a noise estimation value for estimation of the noise of the input image according to a result of the comparison;
(e) performing filtering for elimination of the noise of the input image based on the selectively updated noise estimation value.

9. The method of claim 8, wherein operation (d) comprises adding a result of motion estimation for the current block to the noise estimation value only when the calculated difference is less than the predetermined threshold value, and the calculated difference is a mean of absolute differences of the current block.

10. The method of claim 8, wherein operation (d) comprises adding a variance of the current block to the noise estimation value when the calculated difference is less than the predetermined threshold value, and the noise estimation value is a sum of variances over all previous blocks of the current block in a current frame, in which the previous blocks are processed by operations (a) through (d) and have calculated differences that are less than the predetermined threshold value.

11. The method of claim 8, wherein operation (d) comprises adding a result of subtracting a predetermined motion compensation value from the calculated difference to the noise estimation value when the calculated difference is less than the predetermined threshold value, and the noise estimation value is a sum of variances over all previous blocks of the current block in a current frame, in which the previous blocks are processed by operations (a) through (d) and have calculated differences that are less than the predetermined threshold value.

12. A method of encoding video, the method comprising:
(a) estimating a motion vector for a predetermined-size current block of the input image;
(b) calculating a difference between a block corresponding to the estimated motion vector and the current block;
(c) comparing the calculated difference with a predetermined threshold value;
(d) selectively updating a noise estimation value for estimation of the noise of the input image according to a result of the comparison;
(e) determining a modified quantization weight matrix based on the updated noise estimation value;
(f) performing discrete cosine transform on the input image; and
(g) quantizing the discrete cosine transformed input image using the modified quantization weight matrix.

13. The method of claim 12, wherein operation (d) is performed for the current block only when the calculated difference is less than a predetermined threshold value.

14. The method of claim 12, wherein operation (d) comprises adding a variance of the current block to the noise estimation value when the calculated difference is less than the predetermined threshold value, and the noise estimation value is a sum of variances over all previous blocks of the current block in a current frame, in which the previous blocks are processed by operations (a) through (d) and have calculated differences that are less than the predetermined threshold value.

15. The method of claim 12, wherein operation (d) comprises adding a result of subtracting a predetermined motion compensation value from the calculated difference to the noise estimation value when the calculated difference is less than the predetermined threshold value, and the noise estimation value is a sum of variances over all previous blocks of the current block in a current frame, in which the previous blocks are processed by operations (a) through (d) and have calculated differences that are less than the predetermined threshold value.

16. The method of claim 15, wherein operation (d) comprises determining whether the current block is the last block of the current frame and generating the information about the noise based on the noise estimation value and the number of blocks of the current frame that have calculated differences that are less than the predetermined threshold value, when the current block is the last block of the current frame.

17. The method of claim 12, wherein in operation (e), one of a plurality of modified quantization weight matrixes that are classified according to the amount of noise of the input image is selected.

18. A computer-readable recording medium having recorded thereon a program for implementing a method of estimating noise of an input image, the method comprising:
(a) estimating a motion vector for a predetermined-size current block of the input image;
(b) calculating a difference between a block corresponding to the estimated motion vector and the current block;
(c) comparing the calculated difference with a predetermined threshold value;
(d) selectively updating a noise estimation value for estimation of the noise of the input image according to a result of the comparison;
(e) generating information about the noise based on the selectively updated noise estimation value.

19. A computer-readable recording medium having recorded thereon a program for implementing a method of estimating and eliminating noise of an input image, the method comprising:
(a) estimating a motion vector for a predetermined-size current block of the input image;
(b) calculating a difference between a block corresponding to the estimated motion vector and the current block;
(c) comparing the calculated difference with a predetermined threshold value;
(d) selectively updating a noise estimation value for estimation of the noise of the input image according to a result of the comparison;
(e) performing filtering for elimination of the noise of the input image based on the selectively updated noise estimation value.

20. A computer-readable recording medium having recorded thereon a program for implementing a method of encoding video, the method comprising:
(a) estimating a motion vector for a predetermined-size current block of the input image;
(b) calculating a difference between a block corresponding to the estimated motion vector and the current block;
(c) comparing the calculated difference with a predetermined threshold value;
(d) selectively updating a noise estimation value for estimation of the noise of the input image according to a result of the comparison;
(e) determining a modified quantization weight matrix based on the updated noise estimation value;
(f) performing discrete cosine transform on the input image; and
(g) quantizing the discrete cosine transformed input image using the modified quantization weight matrix.

21. An apparatus for estimating noise of an input image, the apparatus comprising:
a motion estimation unit estimating a motion vector for a predetermined-size current block of the input image and calculating a difference between a block corresponding to the estimated motion vector and the current block;
a comparing unit comparing the calculated difference with a predetermined threshold value; and
a noise calculating unit selectively updating a noise estimation value for estimation of the noise of the input image according to a result of the comparison and generating information about the noise based on the selectively updated noise estimation value.

22. The apparatus of claim 21, wherein the noise calculating unit adds a result of motion estimation for the current block to the noise estimation value only when the calculated difference is less than a predetermined threshold value, and the calculated difference is a mean of absolute values of the current block.
